(19) United States
(12) Patent Application Publication
(10) Pub. No.: US 2020/0265370 A1
(43) Pub. Date: Aug. 20, 2020

(54) VEHICLE CONTROL SYSTEM BASED ON DETENTION TIME

(71) Applicant: OMNITRACS, LLC, Dallas, TX (US)

(72) Inventor: Dale Richard PEAY, Olive Branch, MS (US)

(21) Appl. No.: 16/279,493

(22) Filed: Feb. 19, 2019

(51) Int. Cl. G06Q 10/06; G01C 21/34; G06Q 10/10; G06Q 10/08

(52) U.S. Cl. CPC G06Q 10/063116; G01C 21/3453; G06Q 10/063114; G06Q 10/08355; G06Q 10/1097

(57) ABSTRACT

Aspects of the present disclosure provide techniques for analyzing telematics data received from electronic logging devices (ELDs) attached to one or more trucks in a fleet in order identify shippers that routinely exceed average industry detention time. Flagging such shippers may also allow the remote fleet management system to allocate assets based on anticipated detention time at each shipping facility.

### BACKGROUND

Aspects of the present disclosure relate generally to vehicle control systems, such as in the trucking industry, and, more particularly, to a vehicle control system based on detention time reporting.

Detention time refers to the time a commercial motor vehicle may experience at a shipping and/or receiving facility because of delays associated with loading and/or unloading of cargo. Specifically, in the trucking and shipping industry, “detention time” may refer to an event where the vehicle has to wait more than 2 hours (e.g., average time it should take to load or unload cargo from a truck) at the origin pickup location or the destination delivery location.

A recent report by the U.S. Department of Transportation analyzing operations of commercial motor vehicles found that detention time—unproductive and inefficient time spent waiting—not only is economically costly (e.g., costing U.S. carriers $3.08 billion annually), but may also contribute to higher likelihood of crashes and violation of safety regulations. For example, in the United States, current hours of service (HOS) regulations limit the number of hours a driver of the commercial vehicle can work per day to a 14 hour on-duty period, including a maximum of 11 hours driving. However, vehicles that experience detention time may be more likely to have relatively higher driving speeds, as compared to vehicles that experience no or lower detention times, e.g., to enable the vehicle to reach their destination within the HOS limit of the driver. Alternatively, or in addition, and/or vehicles that experience detention time may be more likely to operate beyond the HOS limits of the driver. Excessively long driving or working hours in combination with unsafe driving to mitigate delays caused by detention time may contribute to crashes and regulation violations. Moreover, the U.S. Department of Transportation has stated that accurate data on detention time does not exist as it is difficult to identify detention time from legitimate loading and unloading time.

Thus, considering that nearly every good consumed by households and businesses, at some point, is transported on a commercial vehicle, the safety, efficiency, and reliability of an industry that forms such an integral part of society is vital.

### SUMMARY

Aspects of the present disclosure provide techniques for a fleet control system that allocates assets based on anticipated detention time at one or more shipping facilities. The fleet control system may receive and analyze telematics data from electronic logging devices (ELDs) attached to one or more trucks in a fleet in order to identify shipping facilities that routinely exceed average industry detention time. Identifying such shippers allows the fleet control system to control asset allocation based on anticipated detention time at each shipping facility.

In one example, a method of controlling a vehicle associated with trucking is disclosed. The method may comprise receiving, at a network-based control computer (NCC), vehicle data via a computer devices associated with a vehicle, wherein the vehicle data includes location information of the vehicle. The method may further comprise determining that the vehicle has entered a shipping facility boundary at a first time, wherein the shipping facility boundary is a geo-fenced area identified by the NCC. The method may further comprise determining that the vehicle has exited the shipping facility boundary at a second time subsequent to the first time. The method may further comprise calculating a total accrued detention time based on elapsed time between the first time and the second time. The method may further comprise generating a detention time report for the shipping facility based on the total accrued detention time of the vehicle.

In another example, a computer device of controlling a vehicle associated with trucking is disclosed. The computer device may include a memory configured to store instructions, and a processor communicatively coupled with the memory. The processor may be configured to execute the instructions to receive, at a NCC, vehicle data via a computer devices associated with a vehicle, wherein the vehicle data includes location information of the vehicle. The processor may further be configured to execute the instructions to determine that the vehicle has entered a shipping facility boundary at a first time, wherein the shipping facility boundary is a geo-fenced area identified by the NCC. The processor may further be configured to execute the instructions to determine that the vehicle has exited the shipping facility boundary at a second time subsequent to the first time. The processor may further be configured to execute the instructions to calculate a total accrued detention time based on elapsed time between the first time and the second time. The processor may further be configured to execute the instructions to generate a detention time report for the shipping facility based on the total accrued detention time of the vehicle.

In another example, another method of controlling a vehicle is disclosed. The method may include receiving a plurality of total accrued detention times at a shipping facility from a plurality of vehicles over a time period. The method may further include determining an effective detention time for the shipping facility as a function of the plurality of total accrued detention times from the plurality of vehicles. The method may further include generating a route including the shipping facility for a vehicle, wherein the route includes routing information based on the effective detention time for the shipping facility. The method may further include generating a control command to control a vehicle operating parameter of the vehicle based on the effective detention time in response to the route including the shipping facility. The method may further include transmitting the route and the control command to the vehicle.

In another example, a computer device of controlling a vehicle associated with trucking is disclosed. The computer device may include a memory configured to store instructions, and a processor communicatively coupled with the memory. The processor may be configured to execute the instructions to receive a plurality of total accrued detention times at a shipping facility from a plurality of vehicles over a time period. The processor may further be configured to execute the instructions to determine an effective detention time for the shipping facility as a function of the plurality of total accrued detention times from the plurality of vehicles. The processor may further be configured to execute the instructions to generate a route including the shipping facility for a vehicle, wherein the route includes routing information based on the effective detention time for the shipping facility. The processor may further be configured to execute the instructions to generate a control command to control a vehicle operating parameter of the vehicle based on the effective detention time in response to the route including the shipping facility. The processor may further be configured to execute the instructions to transmit the route and the control command to the vehicle.

The above presents a simplified summary of one or more aspects of the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the present disclosure in a simplified form as a prelude to the more detailed description that is presented later.

To the accomplishment of the foregoing and related ends, the one or more aspects of the present disclosure comprise the features hereinafter fully described and particularly pointed out in the claims. The following description and the annexed drawings set forth in detail certain illustrative features of the one or more aspects of the present disclosure. These features are indicative, however, of but a few of the various ways in which the principles of various aspects of the present disclosure may be employed, and this description is intended to include all such aspects and their equivalents.

### BRIEF DESCRIPTION OF THE DRAWINGS

The disclosed aspects of the present disclosure will hereinafter be described in conjunction with the appended drawings, provided to illustrate and not to limit the disclosed aspects, wherein like designations denote like elements, where a dashed line may indicate an optional element or action, and in which:

FIGS. 1A and 1B are a schematic diagram of example scenario related to detention time reporting in accordance with aspects of the present disclosure;

FIG. 2 is a functional block diagram of example elements of a system in accordance with various aspects of the present disclosure;

FIG. 3A is a flowchart of an example method for generating a detention time report in accordance with various aspects of the present disclosure;

FIG. 3B is a flowchart of an example method for controlling a vehicle with routing in accordance with various aspects of the present disclosure; and

FIG. 4 is a block diagram of an example of a network-based control computer (NCC) in accordance with the present disclosure.

### DETAILED DESCRIPTION

As discussed above, detention times for commercial motor vehicle operators are prohibitively costly with respect to both economic damages as well as safety hazards. Aspects of the present disclosure provide techniques for analyzing telematics data received from ELDs attached to one or more trucks in a fleet in order to identify shippers that routinely exceed average industry detention time. Detention time may correspond to an amount of time a vehicle is located at a facility to load or unload cargo. In some cases, detention time corresponds to a given appointment time. Also, in some cases, a certain amount of time (such as, but not limited to, 2 hours) may be allotted for loading or unloading, and such allotted time may not be included in the detention time. In some cases, Flagging such shippers may also allow the remote network-based control computer (NCC) and/or fleet operator to allocate assets based on anticipated detention time at each shipping facility and/or accrue charges based on the determined detention time. For purposes of this disclosure, the term network-based control computer and network management center may be used interchangeably.

In an implementation, for example, if the NCC and/or fleet operator executing the described solution determines that a driver assigned to pick up a cargo is running short on available driving or on-duty hours due to detention time at the shipping facility, the NCC and/or fleet operator may reallocate resources (e.g., drivers or vehicles) to pick up the cargo in order to allow the driver with short HOS to take the required 10 hour break without delaying the delivery of the cargo.

Additionally or alternatively, in some implementations, the determination of total accrued detention times at a particular facility may allow the NCC and/or fleet operator to update its pricing schedule charged for servicing a particular shipping facility. For example, updating a pricing schedule may include, but is not limited to, charging higher fees for shippers that routinely exceed average detention times in order to minimize the economic impact to fleet operators and/or negotiating one or more other rates that take into account the identified detention time of the shipper.

Alternatively or in addition, in some implementations, the determination of total accrued detention times at a particular facility may allow the NCC and/or fleet operator to collect detention time charges, which may be credited to the operator or driver and/or debited to the shipper. The detention time charges may be a fee corresponding to the amount of detection time, which may include an rate per hour or day agreed upon between the operator and the shipper, and/or which may include a compensation fee for the driver.

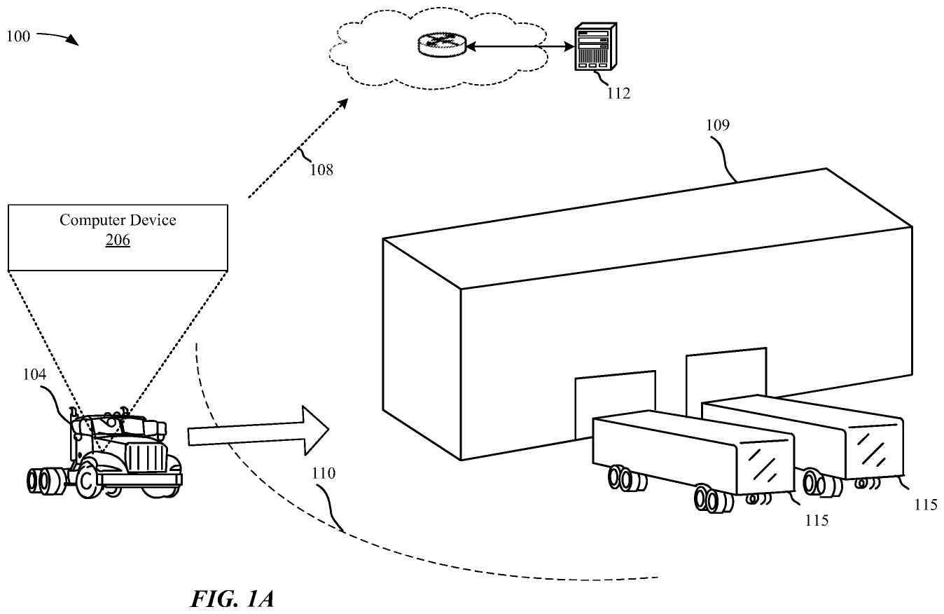

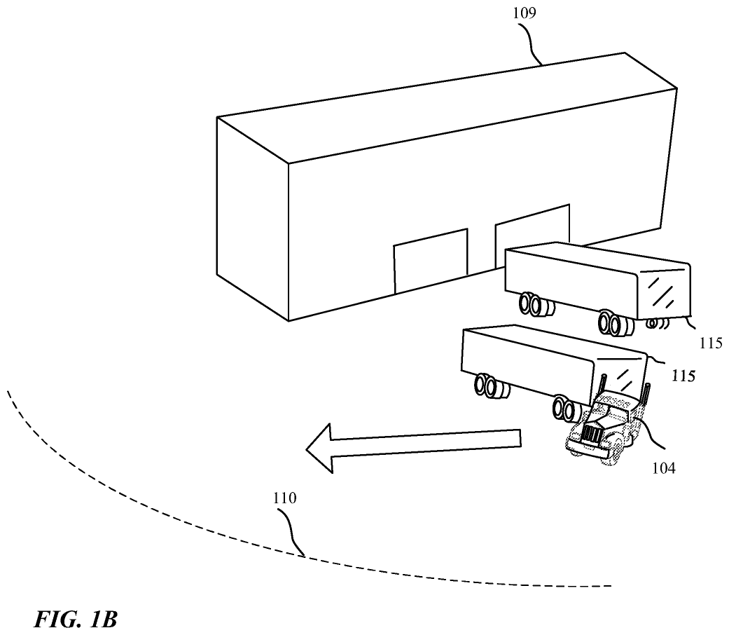

Various aspects are now described in more detail with reference to the FIGS. 1-4. In the following description, for purposes of explanation, numerous specific details are set forth in order to provide a thorough understanding of one or more aspects. It may be evident, however, that such aspect(s) may be practiced without these specific details. Additionally, the term “component” as used herein may be one of the parts that make up a system, may be hardware, firmware, and/or software stored on a computer-readable medium, and may be divided into other components.

The following description provides examples of implementations of the described system based on the principles described herein, but it should be understood that these examples are not intended to limit the scope of the claims. For instance, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined with other features described in other examples.

FIGS. 1A and 1B, discussed concurrently here, include one example of a system 100 for implementing techniques for the network-based control computer (NCC) 112 generating detention time reports by accumulating data collected from one or more vehicles 104 in a fleet. As noted above, detention time refers to the time commercial motor vehicle operators may experience at shipping and receiving facilities 109 because of excessive delays associated with the loading and unloading of cargo onto trailers 115. Specifically, in the trucking and shipping industry, “detention time” may refer to any time drivers have to wait more than 2 hours (e.g., average time it should take to load or unload cargo from a truck) at the origin pickup or destination delivery location.

In some examples, a fleet may include one or more vehicles 104, each vehicle having at least one tractor. In some examples, the one or more vehicles 104, including the tractors, may be equipped with a computer device 206. Each computer device 206 may include electronic logging device (ELD) functionality configured to collect and transmit data associated with the driver and/or the operation of the tractor 104 to the NCC 112 via wireless links (e.g., cellular or satellite communication). Additionally, each computer device 206 and/or its ELD functionality can be configured to perform calculations associated with one or more vehicles using any of the collected data. In some examples, the collected data may include driver data (e.g., driver identification, driver's hours of service (HOS)) or vehicle data such as the location of the vehicle or tractor 104. The driver and/or vehicle data may be periodically (or based on trigger) to the NCC 112.

Given the extensive economic and safety costs associated with detention times at any shipping and receiving facility 109, the NCC 112 may receive the data collected by computer devices 206 of one or more vehicles 104. To this end, the NCC 112 may geo-fence 110 one or more facilities 109. Geo-fencing is a technique for setting forth a virtual perimeter for a real-world geographic area. Thus, location-aware devices, such as computer devices 206 may trigger an alert to the NCC 112 when entering or exiting a geo-fence.

In some examples, the vehicle 104, upon entering the geo-fenced 110 perimeter for a shipping and receiving facility 109, may transmit the vehicle data, along with driver data to the NCC 112. Upon receiving the vehicle and driver data, the NCC 112 may identify the HOS for the driver (e.g., based on driver ID) associated with the vehicle 104. In some aspects, the NCC 112 may determine the available driving hours and/or on-duty hours remaining for the driver based on the HOS information received by the NCC 112. Additionally, the NCC 112 may record the time (e.g., first time period) when the vehicle 104 enters the geo-fenced 110 perimeter of the facility 109.

In some scenarios, the facility 109 may be slow in loading or unloading cargo into the trailers 115 that may be scheduled to be picked up by the vehicle 104. As discussed above, in the industry, the average time to load or unload cargo from a trailer 115 is generally no more than 2 hours. Any time excess of 2 hours may result in the driver being unable to complete the pickup and return to the destination and/or a rest stop (e.g., to take mandatory breaks after consecutive 14 hour on-duty time). Thus, in instances that the trailer 115 is not ready for immediate pickup by the vehicle 104, the driver may be forced to continue being on-duty and/or driving (e.g., if there is a line of vehicles 104 waiting to get to the loading/unloading dock and the vehicle 104 has to occasionally move the vehicle 104 forward), thereby contributing to accumulation of detention time.

As such, when the vehicle 104 pickups the trailer 115, as shown in FIG. 1B, and exits the geo-fenced perimeter 110 of the facility 109, the computer device 206 associated with the vehicle 104 may again transmit the vehicle and/or driver data to the NCC 112 over wireless network. During this second time period —the time the vehicle 104 exits the geo-fenced perimeter—the NCC 112 may again record the time that the vehicle 104 was able to leave the facility 109. In addition, the NCC 112 may determine the remaining HOS capability of the driver (e.g., driving and on-duty hours still remaining at the second time period). Based on the elapsed time between the first time period and the second time period, the NCC 112 may calculate the total accrued detention time for any particular facility 109. As more data associated with the facility 109 is collected over time via one or more vehicles 104 in a fleet, the NCC 112 generate and maintain an accurate detention time report for any shipping facility 109. The generated reports may allow the NCC and/or fleet operators to update its pricing schedule charged for servicing a particular shipping facility 109 that routinely exceed average detention times.

Additionally or alternatively, the NCC 112 may utilize the detention time information in order to schedule resources (e.g., additional drivers or vehicles). For example, if, at the second time period (e.g., time the vehicle 104 exits the geo-fenced perimeter 110), the NCC 112 may determine that the number of available driving and/or on-duty hours remaining for the driver is less than a threshold (e.g., a level that would prevent the driver from reaching the destination and/or rest stop), the NCC 112 may reassign a second driver to pick-up the trailer 115 carried by the vehicle 104. In such instances, the NCC 112 may reroute another driver to a convenient location such that the trailer 115 may be switched to another vehicle or the driver may be available to take over the vehicle 104.

In some examples, the detention time information may also allow the NCC 115 to preemptively allocate resources based on the anticipated detention time at a facility 109. For example, if a facility 109, on average, is always responsible for 5 hour detention time, the NCC 112 may direct the driver of the vehicle 104 to take a break prior to arriving at the facility 109 or allow another driver with full HOS capability (e.g., 11 hours of driving time remaining) to be assigned to pick-up the trailer 115. As such, any detention time may not impact a driver that is low on available HOS. The NCC 112 may facility the reassignment of resources by transmitting a message to the computer device 106 via the wireless network.

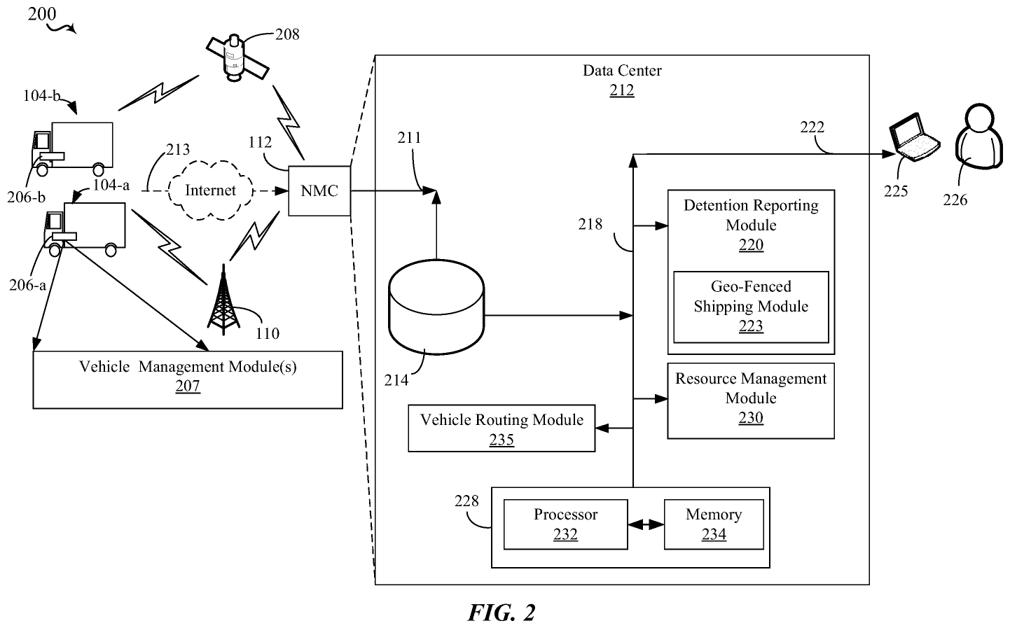

Referring to FIG. 2, in an aspect, a system 200 includes one or more modules and components for determining detention time for one or more shipping facilities. As used herein, the terms “module(s),” or “components” may be one of the parts that make up a device, may be hardware or software or firmware, and may be divided into other modules and/or distributed across one or more processors.

In an aspect, system 200 can comprise a network-based control computer (NCC) 112 configured to communicate with one or more vehicles 104 via the computer device 206 (e.g., ELD and/or mobile device, etc.) located on each tractor 104 or associated with each driver of each tractor 104. In some systems, the computer device 206 may be more than one device, such as an ELD that may communicate with the mobile device (e.g., a smart phone or an in-cab telematics device). The system 200 may include one or more fleets of vehicles 104, each fleet having at least one tractor 104. Typically, a fleet could include many tens, hundreds or thousands of vehicles. An example fleet is illustrated as having two vehicles 104. Each computer device 105 may include ELD functionality configured to collect and transmit data associated with the driver and/or the operation of the tractor 104 to the NCC 112. Also, in some implementations, each computer device 105 and/or its ELD functionality can be configured to perform calculations associated with one or more fleet using any of the collected data. In some examples, the collected data may include the driver or vehicle data such as the HOS information for the driver, location of the tractor 104 (alternatively “vehicle”), or telematics information associated with the tractor 104.

In an example implementation, the one or more tractors or vehicles 104 may be equipped with the computer device 206 in the form of a mobile device in communication with a separate ELD, where the mobile device may function as an in-cab telematics device. In some instances, the mobile device may be a smart phone or tablet configured to receive and process signals and information. In some instances, the ELD may be in communication with the mobile device to allow the collected information to be displayed on the mobile device. To this end, the computer device 206 in the form of either the ELD or the mobile device may include a vehicle management module(s) 207 to perform one or more functions of the present disclosure, including collecting and transmitting driver and/or vehicle data to a remote network-based control computer 112.

In some implementations, the computer device 206 may include a processor configured to execute one or more vehicle management modules 207 and establish communication with external devices, such as NCC 112, via a communication network (e.g., a terrestrial or satellite-based wireless network). The computer device 105 may also include a memory configured to store computer-readable code that may define all or part of the vehicle management modules 207 and also to store data associated with the components and/or computer device 206. The computer device 206 may also include a user interface or display, a mobile application server, and a communications module (e.g., including the one or more transceivers, and one or more of terrestrial and Wi-Fi modems, one or more antennae, a GPS module, and a satellite communications module).

As an example only, each tractor 104 may be in bi-directional communication via the computer device 206 with NCC 112 over at least one communication channel. In the example shown in FIG. 2, each tractor 104 is in bi-directional communication with the NCC 112 over at least one of a satellite-based communication system 208 or a terrestrial-based system 110 (e.g., a wireless communication system using a communication protocol/technology such as, but not limited to, 5G or New Radio, GSM, CDMA, TDMA, WCDMA, EDGE, OFDM, GPRS, EV-DO, LTE, WiFi, Bluetooth), or, when the vehicle is stopped, via a wired connection 213 through the Internet. Depending on many factors, data may be exchanged with the vehicles 104 using one or both of the satellite communication system 208 and the terrestrial-based communication system 110.

In an aspect, many different types of data are collected and transferred from the vehicles 104 to the NCC 112. Examples of such data include, but are not limited to, vehicle performance data, driver performance data, critical events, messaging and position data, location data, HOS data and many other types of data. All of the information that is communicated to and from the vehicles 104 may be processed via the NCC 112. The NCC 112 can be thought of as a data clearinghouse that receives all data that is transmitted to and received from the vehicles 104. Moreover, in an aspect, NCC 112 may include one or more back-end servers. Thus, in some aspects, the collected information may periodically (e.g., every x minutes, where x is a whole number, or once a day, or upon availability of a wired or wireless connection) be transmitted from the computer device 206 to the NCC 112 for analysis and record keeping.

The system 200 also includes a data center 212, which may be part of or in communication with NCC 112. The data center 212 illustrates one possible implementation of a central repository for all of the data received from each of the vehicles 104. As an example, as mentioned above many different types of data are transmitted from the computer devices 206 associated with each of the vehicles 104 to the NCC 112. In the case where data center 212 is in communication with NCC 112, the data may be transmitted via connection 211 to the data center 212. The connection 211 may comprise any wired or wireless dedicated connection, a broadband connection, or any other communication channel configured to transport the data. Moreover, in an aspect, data center 212 may include one or more back-end servers analyzing the one or more parameters transmitted from the one or more computer devices 105. Additionally or alternatively, data may also be exchanged between the plurality of computer devices 105 using, for example, peer-to-peer (P2P) communication without the involvement of the NCC 112.

In an aspect, the data center 212 may include a data warehouse 214 for receiving the data from the computer device 105 relating to the tractor 104. In an aspect, for example, data center 212 may include any number of application servers and data stores, where each may be associated with a separate fleet and/or driver management or performance data. In an aspect, each application server and data store may include a processor, memory including volatile and non-volatile memory, specially-programmed operational software, a communication bus, an input/output mechanism, and other operational systems. For example, an application server may be a services portal (SP) server that receives, for example, messaging and positioning (M/P) data from each of the vehicles 104. Another application server, for example only, may include one or more servers related to safety and compliance, such as a quick deployment center (QDC) server that receives, for example, critical event (CE) data from each of the vehicles 104. Further, for example, another application server may be vehicle and driver performance data related to fuel usage and/or cost from each of the vehicles 104. It should be understood that the above list of example servers is for illustrative purposes only, and data center 212 may include additional and/or different application servers.

Additionally or alternatively, the data center 212 may include a detention reporting module 220 for determining the total accrued detention times for one or more facilities based on data collected from one or more vehicles 104 in the fleet. Thus, as more vehicles 104 provide data to the detention reporting module 220, the NCC 112 may be configured to

In some aspect, the trailer identification component 207 may further communicate with a terminal device 225, which can be a user interface portal, a web-based interface, a personal computer (PC), a laptop, a personal data assistant (PDA), a smart phone, a dedicated terminal, a dumb terminal, or any other device over which a user 226, such as a manager or operator responsible for monitoring a fleet of vehicles 104, may communicate.

In an aspect, the data center 212 may include an analysis engine 228 to analyze the data received from the computer device 105. The analysis engine 228 includes a processor 232 and a memory 234 the respectively execute and store instructions and data associated the operation of the data center 212. Although shown as residing within the data center 212, the analysis engine 228 may reside elsewhere, and may be implemented as a distributed system in which the processor 232 and the memory 234 may include one or more processor and memories, and may be located in different places, such as at NCC 112 and/or one or more servers associated with NCC 112 or data center 212.

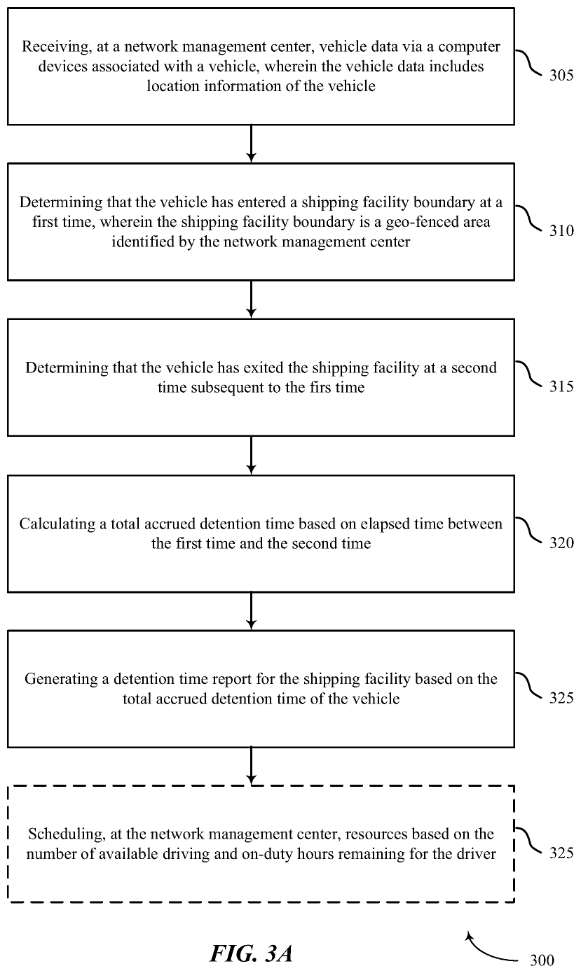

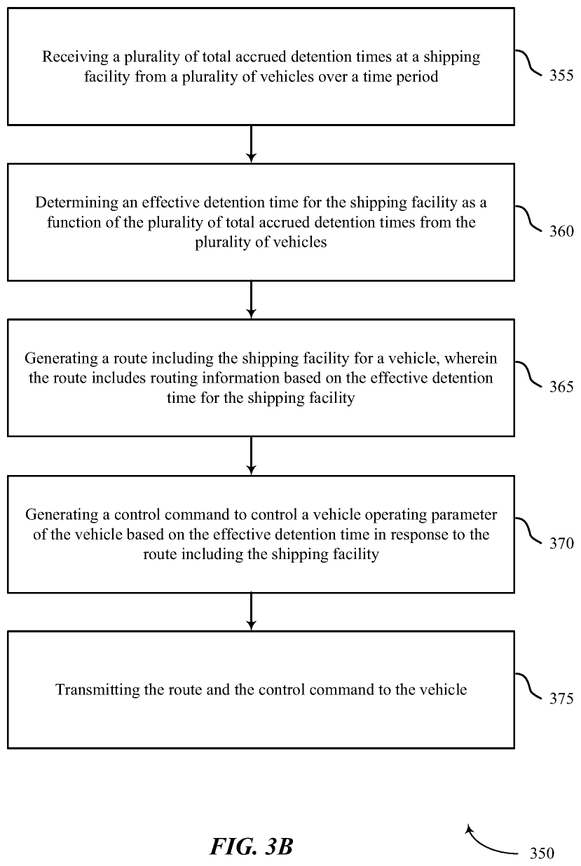

FIG. 3 illustrates one example of a method 300 of controlling a vehicle associated with trucking in accordance with various aspects of the present disclosure. The method 300 may be performed by the NCC 112 and/or data center 212 discussed with reference to FIG. 2.

At block 305, the method 300 may include receiving, at a NCC, vehicle data via a computer device associated with a vehicle. The vehicle data may include location information of the vehicle. In some examples, the NCC may further receive driver information such as HOS information for the driver associated with the vehicle. Specifically, the method may include receiving, at the NCC, HOS information for the driver associated with the vehicle, and determining a number of available driving and on-duty hours remaining for the driver in response to the vehicle entering the shipping facility boundary based on the HOS information. Aspects of block 305 may be performed by communications component 415 described with reference to FIG. 2.

At block 310 the method 300 may include determining that the vehicle has entered a shipping facility boundary at a first time. The shipping facility boundary may be a geo-fenced area identified by the NCC in order to allow the NCC to determine whether the vehicle has entered a virtual perimeter for a real-world geographic area. In some aspects, the method may include transmitting an arrival alert indicating the vehicle has entered the shipping facility boundary. The NCC 112 may also determine, at the first time, a number of available driving and on-duty hours remaining for the driver when the vehicle enters the shipping facility based on the HOS information. As discussed below with respect to block 325, determining the number of available driving and on-duty hours may allow the NCC to schedule resources based on the number of available driving and on-duty hours remaining for the driver.

It should also be appreciated that, in some examples, the geo-fence area may be dynamically adjusted, or can be predefined set of boundaries. To this end, the NCC 112 may also provide multiple layers of geo-fenced boundaries around the shipping facility. For example, in one instance, the shipping facility boundary may be geo-fenced with a first boundary of first area (e.g., radius of 5 miles) that may be mapped to the shipping facility. Additionally, the NCC 112 may allow for a second boundary (e.g., extended boundary) around the shipping facility. In some aspects, the extended boundary (or second boundary of second area) may be an expanded geo-fenced area established for the shipping facility that is greater than the first boundary of first area of shipping facility boundary. In general, the multiple layers of geo-fencing may allow for the detention reporting module 220 to more accurately adjust the total accrued detention time in instances that either the shipping facility prevents the vehicles from entering the facility or, for example, there is a line of trucks of waiting to enter the shipping facility that extends beyond the first boundary of the first area of the shipping facility. In such instances, although the vehicles may be available to begin loading or unloading, the delays by the shipping facility may prevent the vehicles from even entering the facility itself. Aspects of block 310 may be performed by geo-fenced shipping module 223 described with reference to FIG. 2.

At block 315, the method 300 may include determining that the vehicle has exited the shipping facility boundary at a second time subsequent to the first time. The method may also include transmitting a departure alert indicating that the vehicle has exited the shipping facility. Additionally, the NCC 112 may determine, at a second time, the number of available driving and on-duty hours remaining for the driver when the vehicle exits the shipping facility based on the HOS information. In some examples, the method may include determining that the number of available driving and on-duty hours remaining for the driver is less than a threshold in response to the vehicle exiting the shipping facility, and reassigning a second driver to pick-up a trailer carried by the vehicle. This may include routing the vehicle to a specified location such that a second driver may pick-up the trailer for remaining journey, thereby allowing the first driver to rest or take regulation mandated off-duty time.

In some aspects, the calculated driving and on-duty hours remaining for HOS regulation at the time of the vehicle exits the shipping facility may allow the NCC 112 to alter a route for the vehicle (e.g., routing the vehicle to rest stop, or a location of interest for the vehicle to meet a second driver). To this end, the method may include determining a route for the vehicle prior to the vehicle entering the shipping facility, and determining an altered route for the vehicle based on the number of available driving and on-duty hours remaining for the driver corresponding to the vehicle exiting the shipping facility. The method may further include transmitting the altered route to the vehicle such that vehicle may redirect to the altered route and/or destination (or intermediate destination such as rest stops). Aspects of block 315 may also be performed by geo-fenced shipping module 223 described with reference to FIG. 2.

At block 320, the method 300 may include calculating a total accrued detention time based on elapsed time between the first time and the second time. In some examples, the total accrued detention time may be adjusted to account for time a vehicle spends between one or more of secondary geo-fenced areas that may be expanded boundaries of the shipping facility greater than the first geo-fenced boundary of the shipping facility. Thus, in some aspects, the method may include determining that the vehicle has entered an extended boundary of the shipping facility at the first time, wherein the extended boundary is an expanded geo-fenced area established for the shipping facility that is greater than the geo-fenced area of shipping facility boundary. As such, the method may include calculating an amount of time that the vehicle takes to reach the shipping facility boundary from the extended boundary of the shipping facility, and adjusting the total accrued detention time by the amount of time. Aspects of block 320 may be performed by detention reporting module 220 described with reference to FIG. 2.

At block 325, the method 300 may include generating a detention time report for the shipping facility based on the total accrued detention time of the vehicle. In some examples, generating a detention time report may include receiving a plurality of total accrued detention times at the shipping facility from a plurality of vehicles over a time period. Thus, in some examples, the generating of the detention time report for the shipping facility may be a function of the plurality of total accrued detention times from the plurality of vehicles and the total accrued detention time accrued by the vehicle. Aspects of block 325 may also be performed by detention reporting module 220 described with reference to FIG. 2.

At block 330, the method 300 may optionally include scheduling, at the NCC 112, resources based on the number of available driving and on-duty hours remaining for the driver. In some aspects, assigning resources may include determining that the number of available driving and on-duty hours remaining for the driver is less than a threshold when the vehicle exits the shipping facility. As such, the NCC 112 may reassign a second driver to pick-up a trailer carried by the vehicle. Such reassignment may allow the cargo to be timely shipped within the HOS regulations for each driver.

In some examples, scheduling resources may include receiving a plurality of total accrued detention times at the shipping facility from a plurality of vehicles over a time period, and generating a route including the shipping facility for the vehicle, wherein the route includes routing information based on the total accrued detention time for the shipping facility. The method may further include generating a control command to control a vehicle operating parameter of the vehicle based on the total accrued detention time in response to the route including the shipping facility, and transmitting the route and the control command to the second vehicle. Aspects of block 330 may be performed by combination of resource management module 230 and vehicle routing module 235 described with reference to FIG. 2.

In addition to scheduling resources, the method may further include determining whether the shipping facility should be added to a “black list of facilities” to avoid due to high detention time for vehicles, or to adjust the fee schedule/detention time fee for requests from the shipping facility. In some examples, the “black list of facilities” may be an actionable database used to create a “black list” rating system of shipping facilities based at least in part on detention times at the one or more facilities that are rated by the database. For example, the method may include comparing the total accrued detention time to a black list threshold, and determining whether to add the shipping facility to a black list of facilities to avoid in response to the total accrued detention time satisfying the black list threshold. Thus, in some examples, the NCC 112, in response to receiving a request to deliver or pickup cargo from the shipping facility, may determine whether the shipping facility is included in the black list. Based on the determination the NCC 112 may either accept the request in response to the shipping facility being not listed in the black list, and/or reject the request in response to the shipping facility being listed in the black list.

Further, in some examples, the method may include setting (or adjusting) a fee schedule for the shipping facility based on the detention time report for the shipping facility. The method may further include determining a detention fee to be applied to a request to deliver or pickup cargo from the shipping facility based on the total accrued detention time for the vehicle at the shipping facility.

FIG. 3B illustrates one example of a method 350 of controlling a vehicle accordance with various aspects of the present disclosure. The method 350 may be performed by the NCC 112 and/or data center 212 discussed with reference to FIG. 2.

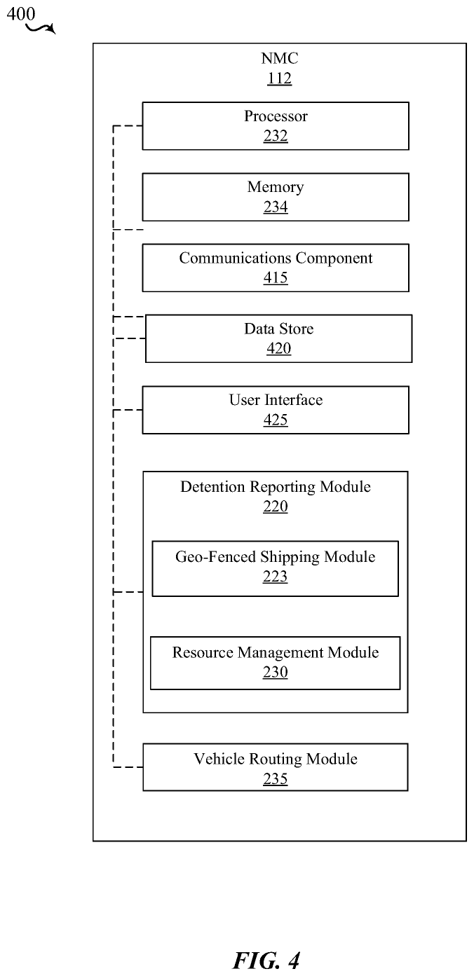

At block 355, the method 350 may include receiving a plurality of total accrued detention times at a shipping facility from a plurality of vehicles over a time period. Aspects of block 355 may be performed by communications component 415 described with reference to FIG. 4.

At block 360, the method 350 may include determining an effective detention time for the shipping facility as a function of the plurality of total accrued detention times from the plurality of vehicles. Aspects of block 360 may be performed by detention reporting module 220 described with reference to FIG. 4.

At block 365, the method 350 may include generating a route including the shipping facility for a vehicle, wherein the route includes routing information based on the effective detention time for the shipping facility. Aspects of block 365 may be performed by vehicle routing module 235 described with reference to FIG. 4.

At block 370, the method 350 may include generating a control command to control a vehicle operating parameter of the vehicle based on the effective detention time in response to the route including the shipping facility. Aspects of block 370 may also be performed by the vehicle routing module 235 described with reference to FIG. 4.

At block 375, the method 350 may include transmitting the route and the control command to the vehicle. Aspects of block 350 may be performed by communications component 415 described with reference to FIG. 4.

Referring to FIG. 4, in an example that should not be construed as limiting, the NCC 112, may include additional components that operate in conjunction with detention reporting module 220 and may be implemented in specially programmed computer readable instructions or code, firmware, hardware, or some combination thereof.

In an aspect, for example, features described herein with respect to the functions of detention reporting module 220 and vehicle routing module 235 may be implemented in or executed using one or any combination of processor 232, memory 234, communications module 415, and data store 420. For example, detention reporting module 220 and vehicle routing module 235 may be defined or otherwise programmed as one or more processor modules of processor 232. Further, for example, detention reporting module 220 and vehicle routing module 235 may be defined as a computer-readable medium (e.g., a non-transitory computer-readable medium) stored in memory 234 and/or data store 420 and executed by processor 232. Moreover, for example, inputs and outputs relating to operations of detention reporting module 220 and vehicle routing module 235 may be provided or supported by communications module 415, which may provide a bus between the modules of NCC 112 or an interface for communication with external devices or modules.

In some examples, the detention reporting module 220 may include receive, at a NCC, vehicle data via a computer device associated with a vehicle, wherein the vehicle data includes location information of the vehicle. The detention reporting module 220 may determine that the vehicle has entered a shipping facility boundary at a first time. In some aspects, the geo-fenced shipping module 223 may establish a geo-fenced area around the shipping facility boundary. In some aspects, the geo-fenced shipping module 223 may provide multiple layers of geo-fenced boundaries around the shipping facility. For example, in one instance, the shipping facility boundary may be geo-fenced with a first boundary of first area (e.g., radius of 5 miles) that may be mapped to the shipping facility. Further, the geo-fenced shipping module 223 may allow for a second boundary (e.g., extended boundary) around the shipping facility. In some aspects, the extended boundary (or second boundary of second area) may be an expanded geo-fenced area established for the shipping facility that is greater than the first boundary of first area of shipping facility boundary. Although described with reference to two layers of geo-fenced boundaries, it should be understood by those of ordinary skill in the art that the number layers may be more than two and may be configurable for each shipping facility. In general, the multiple layers of geo-fencing may allow for the detention reporting module 220 to more accurately adjust the total accrued detention time in instances that either the shipping facility prevents the vehicles from entering the facility or, for example, there is a line of trucks of waiting to enter the shipping facility that extends beyond the first boundary of the first area of the shipping facility. In such instances, although the vehicles may be available to begin loading or unloading, the delays by the shipping facility may prevent the vehicles from even entering the facility itself.

As such, the detention reporting module 220 calculate an amount of time that the vehicle takes to reach the shipping facility boundary (e.g., the first boundary of first area) from the extended boundary (e.g., the second boundary of second area) of the shipping facility. The amount of time the vehicle spends between the multiple layers of geo-fenced boundaries may be adjusted (e.g., added) to the total accrued detention time for the shipping facility. In some aspects, the detention reporting module 220 may compare the total accrued detention time for the shipping facility to a black list threshold (e.g., 3 hours of detention time), and add the shipping facility to the black list of facilities to avoid in response to the total accrued detention time satisfying the black list threshold. As such, the detention reporting module 220 may either accept or reject requests to deliver or pickup cargo from the shipping facility by determining whether the shipping facility is included in the black list.

Additionally or alternatively, the detention reporting module 220 may set (or adjust) a fee schedule for the shipping facility based on the detention time report for the shipping facility. Adjusting the fee schedule may include charging a premium to the requests to deliver or pickup cargo from the shipping facility. In other examples, the detention reporting module 220 may determine (and add) a detention fee to be applied to a request to deliver or pickup cargo from the shipping facility based on the total accrued detention time for the vehicle at the shipping facility. The detention reporting module 220 may further determine when the vehicle has exited the shipping facility at a second time subsequent to the first time. As such, the detention reporting module 220 may calculate a total accrued detention time based on elapsed time between the first time and the second time, and generate a detention time report for the shipping facility based on the total accrued detention time of the vehicle.

In some examples, the detention reporting module 220 may include receive a plurality of total accrued detention times at a shipping facility from a plurality of vehicles over a time period, and determine an effective detention time for the shipping facility as a function of the plurality of total accrued detention times from the plurality of vehicles.

In some examples, the vehicle routing module 235 may generate a route including the shipping facility for a vehicle, wherein the route includes routing information based on the effective detention time for the shipping facility. The vehicle routing module 235 may further generate a control command to control a vehicle operating parameter of the vehicle based on the effective detention time in response to the route including the shipping facility, and transmit the route and the control command to the vehicle.

Processor 232 can include a single or multiple set of processors or multi-core processors. Moreover, processor 232 can be implemented as an integrated processing system and/or a distributed processing system. Memory 234 may operate to allow storing and retrieval of data used herein and/or local versions of applications and/or software and/or instructions or code being executed by processor 232, such as to perform the respective functions of detention reporting module 220 described herein. Memory 234 can include any type of memory usable by a computer, such as random access memory (RAM), read only memory (ROM), tapes, magnetic discs, optical discs, volatile memory, non-volatile memory, and any combination thereof.

Communications module 415 is operable to establish and maintain communications with one or more internal components/modules or external devices utilizing hardware, software, and services as described herein. Communications component 415 may carry communications between modules on NCC 112, as well as between user and external devices, such as devices located across a communications network and/or devices serially or locally connected to NCC 112. For example, communications component 415 may include one or more buses, and may further include transmit chain modules and receive chain modules associated with a transmitter and receiver, respectively, or a transceiver, operable for interfacing with external devices.

Additionally, data store 420, which can be any suitable combination of hardware and/or software, which provides for mass storage of information, databases, and programs employed in connection with aspects described herein. For example, data store 420 may be a data repository for applications not currently being executed by processor 232.

The NCC 112 may additionally include a user interface module 425 operable to receive inputs from a user, and further operable to generate outputs for presentation to the user. User interface module 425 may include one or more input devices, including but not limited to a keyboard, a number pad, a mouse, a touch-sensitive display, a navigation key, a function key, a microphone, a voice recognition module, any other mechanism capable of receiving an input from a user, or any combination thereof. Further, user interface module 425 may include one or more output devices, including but not limited to a display, a speaker, a haptic feedback mechanism, a printer, any other mechanism capable of presenting an output to a user, or any combination thereof.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGS. 1-4 which may illustrate various process flows.

As used in this description, the terms “module,” “components,” “database,” “module,” “system,” and the like are intended to refer to a computer-related entity, either hardware, firmware, a combination of hardware and software, software, or software in execution. For example, a module may be, but is not limited to being, a process running on a processor, a processor, an object, an executable, a thread of execution, a program, and/or a computer. By way of illustration, both an application running on a computing device and the computing device may be a module. One or more modules may reside within a process and/or thread of execution, and a module may be localized on one computer and/or distributed between two or more computers. In addition, these modules may execute from various computer readable media having various data structures stored thereon. The modules may communicate by way of local and/or remote processes such as in accordance with a signal having one or more data packets (e.g., data from one module interacting with another module in a local system, distributed system, and/or across a network such as the Internet with other systems by way of the signal).

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (“CD”), laser disc, optical disc, digital versatile disc (“DVD”), floppy disk and blue-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of controlling a vehicle associated with trucking, comprising:
receiving, at a network-based control computer (NCC), vehicle data via a computer device associated with a vehicle, wherein the vehicle data includes location information of the vehicle;
determining that the vehicle has entered a shipping facility boundary at a first time, wherein the shipping facility boundary is a geo-fenced area identified by the NCC;
determining that the vehicle has exited the shipping facility boundary at a second time subsequent to the first time;
calculating a total accrued detention time based on elapsed time between the first time and the second time; and
generating a detention time report for the shipping facility based on the total accrued detention time of the vehicle.

2. The method of claim 1, further comprising:
receiving, at the NCC, hours of service (HOS) information for the driver associated with the vehicle; and
determining a number of available driving and on-duty hours remaining for the driver in response to the vehicle entering the shipping facility boundary based on the HOS information.

3. The method of claim 2, further comprising:
transmitting an arrival alert indicating the vehicle has entered the shipping facility boundary.

4. The method of claim 2, further comprising:
scheduling, at the NCC, resources based on the number of available driving and on-duty hours remaining for the driver.

5. The method of claim 1, further comprising:
receiving, at the NCC, hours of service (HOS) information for the driver associated with the vehicle; and
determining the number of available driving and on-duty hours remaining for the driver in response to the vehicle exiting the shipping facility based on the HOS information.

6. The method of claim 5, further comprising:
transmitting a departure alert indicating the vehicle has exited the shipping facility boundary.

7. The method of claim 5, further comprising:
scheduling, at the NCC, resources based on the number of available driving and on-duty hours remaining for the driver.

8. The method of claim 5, further comprising:
determining that the number of available driving and on-duty hours remaining for the driver is less than a threshold in response to the vehicle exiting the shipping facility; and
reassigning a second driver to pick-up a trailer carried by the vehicle.

9. The method of claim 5, further comprising:
determining a route for the vehicle prior to the vehicle entering the shipping facility;
determining an altered route for the vehicle based on the number of available driving and on-duty hours remaining for the driver corresponding to the vehicle exiting the shipping facility; and
transmitting the altered route to the vehicle.

10. The method of claim 1, further comprising:
receiving a plurality of total accrued detention times at the shipping facility from a plurality of vehicles over a time period; and
wherein the generating of the detention time report for the shipping facility is a function of the plurality of total accrued detention times from the plurality of vehicles and the total accrued detention time accrued by the vehicle.

11. The method of claim 1, further comprising:
receiving a plurality of total accrued detention times at the shipping facility from a plurality of vehicles over a time period;
generating a route including the shipping facility for the vehicle, wherein the route includes routing information based on the total accrued detention time for the shipping facility;
generating a control command to control a vehicle operating parameter of the vehicle based on the total accrued detention time in response to the route including the shipping facility; and
transmitting the route and the control command to the second vehicle.

12. The method of claim 1, further comprising:
comparing the total accrued detention time to a black list threshold; and
adding the shipping facility to a black list of facilities to avoid in response to the total accrued detention time satisfying the black list threshold.

13. The method of claim 12, further comprising:
receiving a request to deliver or pickup cargo from the shipping facility;
determining whether the shipping facility is included in the black list;
accepting the request in response to the shipping facility being not listed in the black list; and
rejecting the request in response to the shipping facility being listed in the black list.

14. The method of claim 1, further comprising:
setting a fee schedule for the shipping facility based on the detention time report for the shipping facility.

15. The method of claim 1, further comprising:
determining a detention fee to be applied to a request to deliver or pickup cargo from the shipping facility based on the total accrued detention time for the vehicle at the shipping facility.

16. The method of claim 1, further comprising:
determining that the vehicle has entered an extended boundary of the shipping facility at the first time, wherein the extended boundary is an expanded geo-fenced area established for the shipping facility that is greater than the geo-fenced area of shipping facility boundary;
calculating an amount of time that the vehicle takes to reach the shipping facility boundary from the extended boundary of the shipping facility;
adjusting the total accrued detention time by the amount of time.

17. A method of controlling a vehicle, comprising:
receiving a plurality of total accrued detention times at a shipping facility from a plurality of vehicles over a time period;
determining an effective detention time for the shipping facility as a function of the plurality of total accrued detention times from the plurality of vehicles;
generating a route including the shipping facility for a vehicle, wherein the route includes routing information based on the effective detention time for the shipping facility;
generating a control command to control a vehicle operating parameter of the vehicle based on the effective detention time in response to the route including the shipping facility; and
transmitting the route and the control command to the vehicle.

18. A computer device of controlling a vehicle associated with trucking, comprising:
a memory configured to store instructions;
a processor communicatively coupled with the memory, the processor configured to executed the instructions to:
receive, at a network-based control computer (NCC), vehicle data via a computer device associated with a vehicle, wherein the vehicle data includes location information of the vehicle;
determine that the vehicle has entered a shipping facility boundary at a first time, wherein the shipping facility boundary is a geo-fenced area identified by the NCC;
determine that the vehicle has exited the shipping facility boundary at a second time subsequent to the first time;
calculate a total accrued detention time based on elapsed time between the first time and the second time; and
generate a detention time report for the shipping facility based on the total accrued detention time of the vehicle.

19. The computer device of claim 18, wherein the processor is further configured to executed the instructions to:
receive, at the NCC, hours of service (HOS) information for the driver associated with the vehicle; and
determine a number of available driving and on-duty hours remaining for the driver in response to the vehicle entering the shipping facility boundary based on the HOS information.

20. A computer device for wireless communications associated with trucking, comprising:
a memory configured to store instructions;
a processor communicatively coupled with the memory, the processor configured to executed the instructions to:
receive a plurality of total accrued detention times at a shipping facility from a plurality of vehicles over a time period;
determine an effective detention time for the shipping facility as a function of the plurality of total accrued detention times from the plurality of vehicles;
generate a route including the shipping facility for a vehicle, wherein the route includes routing information based on the effective detention time for the shipping facility;
generate a control command to control a vehicle operating parameter of the vehicle based on the effective detention time in response to the route including the shipping facility; and
transmit the route and the control command to the vehicle.
